(19) United States
(12) Patent Application Publication
(10) Pub. No.: US 2023/0251672 A1
(43) Pub. Date: Aug. 10, 2023

(54) ASSISTIVE ROBOTIC MANIPULATION OF BUILDING CONTROLS

(71) Applicant: Alarm.com Incorporated, Tysons, VA (US)

(72) Inventors: Donald Gerard Madden, Columbia, MD (US); Glenn Tournier, Vienna, VA (US); Daniel Todd Kerzner, McLean, VA (US)

(21) Appl. No.: 18/102,873

(22) Filed: Jan. 30, 2023

Related U.S. Application Data
(60) Provisional application No. 63/308,840, filed on Feb. 10, 2022.

(51) Int. Cl. G05D 1/10; G05B 13/02; G05D 1/00; B64U 10/14

(52) U.S. Cl. CPC G05D 1/101; G05B 13/0265; G05D 1/0016; G05D 1/0033; B64U 10/14; B64U 2101/31

(57) ABSTRACT

Methods, systems, and apparatus, including computer programs encoded on computer-storage media, for assistive robotic manipulation of building controls. In some implementations, a method includes obtaining sensor data from a property at a first time; obtaining sensor data from the property at a second time; determining whether the sensor data from the first time and the second time satisfy a criteria; in response to determining the criteria is satisfied, generating a mapping between an interface and a device; and providing the mapping to a robot for activating the device.

### CROSS-REFERENCE TO RELATED APPLICATION

This application claims the benefit of U.S. Provisional Application No. 63/308,840, filed Feb. 10, 2022, the contents of which are incorporated by reference herein.

### BACKGROUND

A monitoring system for a property can include various components including sensors, cameras, and other devices. For example, the monitoring system may use the camera to capture images of people or objects of the property.

### SUMMARY

This specification describes techniques, methods, systems, and other mechanisms for assistive robotic manipulation of building controls. A property may include smart devices equipped with automatic control processes as well as devices that are not so equipped. The latter may be referred to as non-smart devices.

According to one implementation of the subject matter, a control unit of a property monitoring system obtains sensor data, such as video data from cameras on a property. The control unit can correlate actions detected in the sensor data in order to determine a mapping between a non-smart device and an effect within the property. For example, the control unit can detect a switch in an “off” position at a first time and a switch in an “on” position at a second time. The control unit can also detect a light off at a first time and a light on at a second time. The control unit can then generate a mapping indicating the switch as a control for the light.

One innovative aspect of the subject matter described in this specification is embodied in a method that includes obtaining sensor data from a property at a first time; obtaining sensor data from the property at a second time; determining whether the sensor data from the first time and the second time satisfy a criteria; in response to determining the criteria is satisfied, generating a mapping between an interface and a device; and providing the mapping to a robot for activating the device.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, the interface is configured to control the device. In some implementations, determining whether the sensor data from the first time and the second time satisfy the criteria includes: determining a difference between the sensor data from the first time and the sensor data from the second time; and comparing the difference to a threshold.

In some implementations, the sensor data from the property at the first time indicates a first status of the interface configured to control the device, and the sensor data from the property at the second time indicates (i) a second status, different than the first status, of the interface configured to control the device and (ii) an effect of the device being controlled by the interface.

In some implementations, the effect of the device being controlled by the interface includes illumination of a portion of the property or area near the property. In some implementations, determining whether the sensor data from the first time and the second time satisfy the criteria includes: comparing the first status of the interface configured to control the device with the second status of the interface configured to control the device.

In some implementations, actions include determining that the comparison satisfies the criteria by determining the first status of the interface configured to control the device is different than the second status.

In some implementations, determining whether the sensor data from the first time and the second time satisfy the criteria includes: comparing one or more values of pixels of an image of the sensor data obtained from the property at the first time with one or more values of pixels of an image of the sensor data obtained from the property at the second time.

In some implementations, prior to providing the mapping to the robot for activating the device, actions include obtaining sensor data corresponding to a first area of the property; detecting an object in the first area using the obtained sensor data; and determining that the device is mapped to and effects the first area. In some implementations, actions include providing the mapping to the robot for activating the device in response to: detecting the object in the first area using the obtained sensor data; and determining that the device is mapped and effects the first area.

In some implementations, actions include determining the device is not a smart device and is configured to be controlled by the interface. In some implementations, determining the device is not a smart device and is configured to be controlled by the interface includes: maintaining data indicating detection of movement of a person interacting with the interface.

In some implementations, the interface is a physical switch or physical button. In some implementations, providing the mapping to the robot for activating the device includes: providing a location of the interface to the robot.

In some implementations, providing the mapping to the robot for activating the device includes: providing instructions to the robot indicating how to access the interface controlling the device. In some implementations, the instructions include flight maneuvers for the robot to perform to access a portion of the interface.

The details of one or more embodiments of the invention are set forth in the accompanying drawings and the description below. Other features and advantages of the invention will become apparent from the description and the drawings.

### BRIEF DESCRIPTION OF THE DRAWINGS

FIG. 1 is a diagram showing an example of a system for assistive robotic manipulation of building controls.

FIG. 2 is a diagram showing an example of a system for assistive robotic manipulation of building controls manipulating building controls.

FIG. 3 is a flow diagram illustrating an example of a process for assistive robotic manipulation of building controls.

FIG. 4 is a flow diagram illustrating an example of a process for an assistive robotic manipulation of building controls system manipulating building controls.

FIG. 5 is a diagram illustrating an example of a property monitoring system.

Like reference numbers and designations in the various drawings indicate like elements.

### DETAILED DESCRIPTION

Automation of building controls, such as lights, appliances, security panels, locks, thermostats, among others, provides great convenience, added security, and important accessibility to users, but can be difficult and costly to implement universally. Barriers to automation include: cost of smart devices vs. standard devices; legacy equipment which is impossible or impractical to upgrade; large amount of specialized labor to upgrade; large numbers of devices in a home (e.g., dozens of light switches) that would need to be replaced; rental properties where upgrading is not permitted by an owner; temporary accommodations where even adding plug-in devices would take a disproportionate amount of time compared to the stay; physical limitations that might keep the user from installing a smart device; connectivity issues that might affect certain devices within the home.

Innovations described in this specification detail a robotic system that can manipulate common building controls in the manner of, or as a complement to, a home automation system.

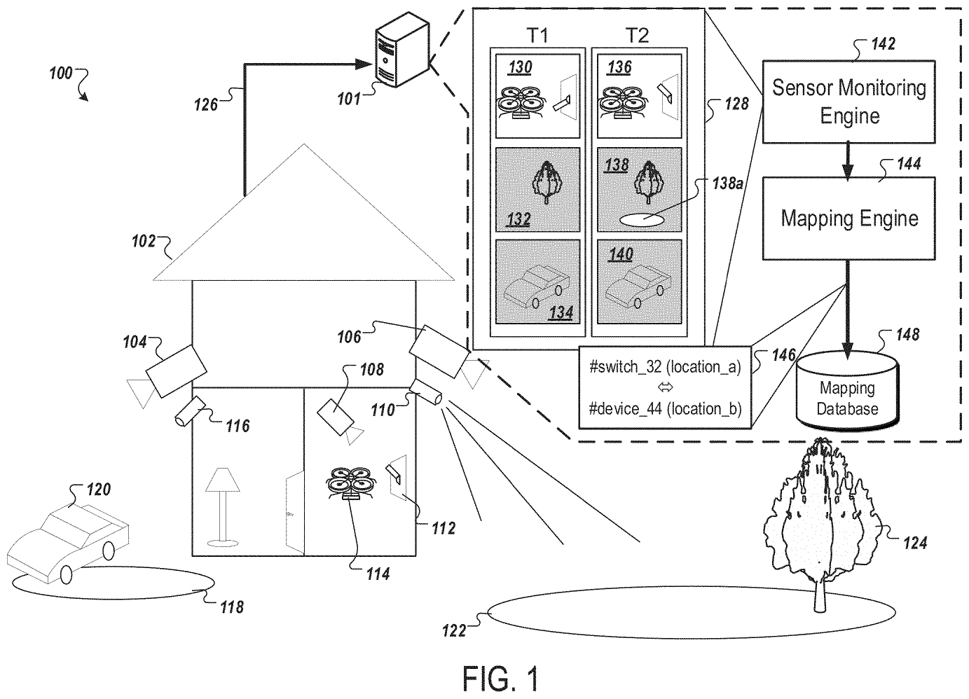

Components of such a system can include: an autonomous mobile robot, such as robot 114 of FIG. 1, with a manipulator capable of activating various controls; a mapping of building controls to functions and/or commands which can either be programmed or learned; a control interface by which a user or software API can command the system.

A robot, such as the robot 114, of the system can move in any way feasible including by ground, such as by wheels, or by air, such as by propellers or wings, and can include one or more manipulator arms. Manipulator arms can have a non-slip/non-marking tip for pressing buttons, flipping switches, among others. Manipulator arms can include a soft, capacitive tip for interacting with touch screen devices. Manipulator arms can be unjointed or have one or more joints depending on the mobility of the robot and the supported interactions. Manipulator arms can include a rotating mechanism to turn knobs/dials/door locks.

A robot of a corresponding system can include a camera or other sensors to allow closed-loop guidance to the control and interaction with the control visual verification of the state of the control (before, during, and after interaction); automatic or human confirmation of the state of the system being controlled (e.g., did the lights go on?); human in the loop assistance or interaction when needed.

In some implementations, a robot includes a speaker to access voice controlled functionality. The robot can include two-way audio to allow a user to interact with an audio device such as a smart speaker, telephone, or intercom.

For example, the robot could fly to an apartment door buzzer/intercom control, press the intercom button, enable two way audio (and, if the intercom system supports it, one way video) so that the user can identify the person at the door, and then the robot can press the button to buzz the person up. The robot can then go to the door, look through the peephole until they see the person (or hear a knock), interact with the person audibly, recognize their face or voice, unlock the door and ask them to come in (or direct them to drop a delivery at the door, among others).

The robot can send data to a control unit, such as the control unit 101 to detect one or more objects, such as the person at the door, the face of the person or voice, an object carried by the person, among others. The control unit can be included in the robot or exist remotely. The control unit can include one or more trained models to detect one or more objects. The models can be trained based on training data including one or more objects for detection, such as specific people or objects e.g., cardboard boxed packages, among others.

A robot can include an infrared energy source such that it can trip passive infrared (PIR) sensors to open doors, turn on lights, among others. The system, such as the system 100 or the system 200, can include an IR transmitter, Bluetooth radio, or other common remote control technology such that it can interact with common devices such as televisions, fans, among others. The system might cycle through common IR commands while observing the device in order to learn how to control the device.

A robot of a system, such as the system 100 or the system 200, can precede a person as they walk and turn on lights or operate other controls ahead of them. The robot might follow behind a person and turn off lights once they have left a room.

A system, such as the system 100 or the system 200, can be directly programmed for each new control by navigating (or directing a user to carry) the robot to each control so that it can record the location and learn the appearance of the control, assigning that control a name or ID, and entering the type of control and what each input does, for example, “Porch light, wall toggle switch, up=on”. For some controls, the system navigates the robot to where the robot can detect the device being controlled, so that it might be able to both verify the state of the device and determine the spatial relationship (e.g., “if I want to light THIS hallway, the switch is HERE”) to allow more complex automations, such as lighting the way to the kitchen at night.

A system as discussed herein can analyze video from its camera and detect a user interacting with controls. In some cases, the system can activate a teaching mode where the system detects actions of the user to learn how to control one or more devices on a property (e.g., a user can activate a hall light, on and off, to teach the system the control and the effect of a light switch controlling the hall light). In some cases, the user can point, or make another gesture, at a control, such as a light switch, and the device it controls, such as a hall light. The system, including one or more control units, can process the data and detect a gesture, such as a finger pointing, and a device or control. Depending on the gesture, the system can detect the devices or controls controlling the devices. For example, for a pointing gesture, one or more processors of a system can detect a vector of direction indicated by the pointing gesture and detect an object from the end of the user's pointing to a device or control. In general, the user can gesture at any object or control and the system can map devices and controls based on the user gesturing to them in sequential gestures.

In some implementations, a system is be pre-trained to detect and identify common controls, programmed on how to manipulate them, and how to validate the functions they commonly control. For example, most wall switches are located at similar heights, have a few different appearances (in a given country), and typically control lights, plugs (often with lights plugged in), and fans.

The system can learn the controls and the mapping in an autonomous manner. For example, the user might unpack the robot in a hotel room it has never seen. The robot could scan the room (e.g., by rotating a camera or other sensor or by moving physically around the room with sensors obtaining data of the room and providing it to an onboard, or remote, control unit for processing as described herein) and detect various objects including controls and devices, such as light switches, phone, a thermostat. With the user's permission, the robot can go to each control and adjust it, such as toggling switches, learning devices they control and what adjustment or position of the control corresponds to what state of operation. For example, the system can determine that a light switch in a downward position corresponds a light being on and vice versa.

In some implementations, a system checks for a complete mapping of devices and performs additional learning if a complete mapping is not satisfied. For example, a complete mapping can be satisfied if all devices in a property have a known control that is stored in a mapping database. The system can scan for light sources and make sure it can map each one to a control or switch. If there is a device that the system does not have a corresponding control for, the system can generate a request for a user to provide a mapping for the unknown device.

As a system investigates each control, the system can prompt the user for a name, or suggest or default to a name based on known past patterns from similar contexts (e.g., hotel room) and the device positions relative to detected objects (e.g., “entryway” can be used to describe devices near a door, “bedside” can be used to describe devices near a bed, where the descriptions can modify an identifier for the device, such as camera, light, or appliance, among others). If a similar control and device are detected in a new property compared to a previous property, the system may adjust the controls of the new property to match the previous property thereby adjusting the new property to the preferences of the user automatically.

In some implementations, machine learning is used to learn or fine-tune the motions required to operate a control. Learning to operate a control can be done through repetitions of trial and error as the robot, such as the robot 114, attempts to use a control and evaluates whether or not an adjustment to the control was effective based on the visual appearance of the control itself (e.g., the robot, or connected control unit, can determine if a control, such as a switch, changes from a first state to a second state or changes by a degree that satisfies a change threshold). The robot can also determine if the adjustment to the control was effective by sensor data of the device the control controls (e.g., determine whether a light corresponding to a control turned on after adjusting the corresponding control).

In some implementations, the system has predefined learning rules. For example, the system can be programmed such that certain controls (e.g., a light switch), certain controls at certain times of day or conditions (e.g., when no one is home), or all controls at certain times of day or conditions are considered safe to try an automated learning approach where a robot adjusts controls until one or more mappings are stored for one or more controls and devices. The system can prevent some controls from being tested in this way, such as fire alarms or a bedroom light when a person is detected in the bed or in the bedroom.

FIG. 1 is a diagram showing an example of a system 100 for assistive robotic manipulation of building controls. The system 100 includes control unit 101 that controls the monitoring system of property 102. The system 100 includes cameras 104, 106, and 108 controlled by the control unit 101. The system 100 also includes the robot 114 controlled by the control unit 101.

The camera 104 is positioned facing car 120 in region 118. The camera 106 is positioned facing tree 124 in region 122. And the camera 108 is positioned facing switch 112. In the example of FIG. 1, the switch 112 is a control. In general, the switch 112 can be any type of control including a remote control, an appliance input, an elevator button, a door buzzer, a car door, and the like.

At time T1, the control unit 101 obtains data from the property 102 including an image 130 depicting the robot 114 near the switch 112 where the switch 112 is in a first position, an image 132 depicting the region 122 and the tree 124 in darkness, and an image 134 depicting the region 118 and the car 120 in darkness. At time T2, the control unit 101 obtains additional data from the property 102 including an image 136 depicting the robot 114 near the switch 112 where the switch 112 is in a second position, an image 138 depicting the region 122 and the tree 124 with a lighted portion 138a, and an image 140 depicting the region 118 and the car 120, again, in darkness.

The control unit 101 includes one or more computer processors configured to perform operations of a sensor monitoring engine 142 and a mapping engine 144. The control unit 101 is configured to store and access data within the mapping database 148.

The sensor monitoring engine 142 obtains the data 128 including images 130, 132, 134, 136, 138, and 140. The sensor monitoring engine 142 processes the images according to one or more image detection algorithms. For example, the sensor monitoring engine 142 can be trained to detect objects within data captured by sensors of a property, such as the tree 124, the car 120, and the switch 112 captured by camera 106, 104, and 108, respectively. Moreover, the sensor monitoring engine 142 can be trained to detect statuses of objects within a property. For example, the sensor monitoring engine 142 can detect a change within a known object, such as an indicator light illuminating, a switch moving position, or an appliance that switches states from on to off or off to on.

In the example of FIG. 1, the sensor monitoring system 142 detects the robot 114 and the switch 112 in both the image 130 and the image 136. The sensor monitoring system 142 further detects a change in the positioning of the switch 112. In general, the sensor monitoring system 142 can be trained using training images that include objects within properties in various states. The sensor monitoring system 142 can then identify the different states along with a detection of the corresponding object. In this way, the sensor monitoring system 142 can detect when an object state changes over time.

The sensor monitoring system 142 detects the switch 112 in a first state corresponding to the switch pointing in a first direction based on processing the image 130. Based on processing a timestamp associated with the image 130 and the image 130, the sensor monitoring system 142 determines that the switch 112 is in the first state at T1. At a later time T2, the sensor monitoring system 142 detects the switch 112 in a second state corresponding to the switch pointing in a second direction based on processing the image 136. Based on processing a timestamp associated with the image 136 and the image 136, the sensor monitoring system 142 determines that the switch 112 is in the second state at T2.

The sensor monitoring system 142 further processes images 132, 134, 138, and 140. The sensor monitoring system 142 can detect states of objects including the region 118 with the car 120 and the region 122 with the tree 124. In some implementations, the sensor monitoring system 142 learns states for the region 118 and the region 122 and then determines the state at T1 and T2 based on historical state data used as training data and collected for the regions 118 and 122. For example, the sensor monitoring system 142 can include one or more trained models. The models can be trained on sensor data representing the regions 118 and 122. The sensor monitoring system 142 can learn multiple classifications including night, day, light on, motion detected, among others. The sensor monitoring system 142 can determine states for current sensor data and previously obtained sensor data. The sensor monitoring system 142 can then compare the determined states to determine if there has been a state change.

In some implementations, the sensor monitoring system 142 works with the robot 114 to determine state changes. For example, the robot 114 can patrol the property 102 during a learning phase. A learning phase can include obtaining permission of a user of the property 102 to adjust controls of the property 102 in order to determine what the controls do. That is, the robot 114 can detect objects, determine they are a likely controller, adjust the control based on a learned or programmed maneuver to adjust the control, e.g., flipping an object that is detected as a switch, and the sensor monitoring system 142 can determine what effect the adjustment caused, if any.

In some implementations, the robot 114 sends a signal to the sensor monitoring system 142 indicating that adjustments will be made or an adjustment has been made. For example, the robot 114 can send a signal to the sensor monitoring system 142 that the robot 114 will adjust the switch 112. The robot 114 can further include a time when the maneuver was completed. The sensor monitoring system 142 can then use the information to search for any detected changes in the sensor data. In some implementations, if the sensor monitoring system 142 does not receive an indication that a control is being adjusted, the sensor monitoring system 142 can save power and processing bandwidth by not looking for state changes. The sensor monitoring system 142 can use the timing of the adjustment provided by the robot 114 to look for state changes within a determined time range corresponding to the adjustment. For example, if the time of adjustment is at T3, the sensor monitoring system 142 can compare sensor data from multiple sensors from time before T3 and from time after T3 to determine what has been affected by the control adjustment, if anything.

If the sensor monitoring system 142 detects no change, it can provide data to the robot 114 to retry the maneuver or send an alert to a user of the property 102 indicating that an adjustment did not produce an effect. The user can then program a correct process into the system 100 for the robot 114 to perform or can simply demonstrate a correct process for adjusting the control. The robot 114 can learn the correct maneuver based on the correct process demonstrated by the user. For example, the robot 114 can use onboard sensors to detect objects of the user, such as hands, feet, and head, in relation to objects detected in the property 102. By detecting the relative positions of the objects of the user and the objects of the property 102, the robot 114 can determine what objects of the property 102 need to be adjusted and how they need to be adjusted. The robot 114 can similarly send detected data to the control unit 101 for central processing.

In some implementations, a user of the system 100 demonstrates a correct maneuver to adjust a control and the maneuver is stored in sensor data obtained by the control unit 101. For example, the control unit 101 can use sensors, such as the cameras 104, 106, and 108 to record visual data. Similar to the learning process of the robot 114, the control unit 101 can determine parts of the user, such as hands, fingers, or the like, based on known characteristics of human anatomy, and can detect objects of the property 102. Based on the interaction of the user with the detected objects of the property 102, the control unit 101 can determine the correct maneuver for a robot, such as the robot 114, to perform to correctly adjust a control.

In the example of FIG. 1, the sensor monitoring system 142 detects the state change of the robot 114 flipping the switch 112 as a control adjustment. The sensor monitoring system 142 detects the switch 112 as a control and the robot 114 as a known control adjuster. When the control state changes from a first state, down, to a second state, up, the sensor monitoring system 142 determines that the control of the switch 112 has been adjusted by the robot 114. The sensor monitoring system 142 can then process obtained sensor data to determine what effect the adjustment made on the property 102.

In some implementations, T1 indicates time before a control adjustment and T2 indicates time after a control adjustment. That is, the sensor data including image 130, 132 and 134, need not be obtained at the same time. Similarly, the sensor data including image 136, 138, and 140 need not be obtained at the same time.

When the sensor monitoring system 142 determines that the control of the switch 112 is adjusted, the sensor monitoring system 142 can process data obtained before the control was adjusted, corresponding to T1, process data obtained after the control was adjusted, corresponding to T2, and compare the processed data to determine the effect of the control adjustment.

In some implementations, the sensor monitoring system 142 merely compares the data from before and after the control and looks for differences in the sensor data. For example, with visual data, the sensor monitoring system 142 can compare the average change in pixel values to determine if there was a change. Pixel value changes above a threshold corresponding to a time of control adjustment can be labeled as an effect of the control adjustment.

In the example of FIG. 1, the sensor monitoring system 142 can compare the images 132 and 138 and determine that the pixel value changes, corresponding to the lighted portion 138a, satisfy a threshold amount of change. The sensor monitoring system 142 can then determine that the effect of the control adjustment was the effect of lighting the portion 138a of the region 122.

In some implementations, the sensor monitoring system 142 detects what state regions of the property 102 correspond to at a time before an adjustment based on data obtained before an adjustment. The sensor monitoring system 142 can also detect what state regions of the property 102 correspond to at a time after an adjustment based on data obtained after an adjustment. The sensor monitoring system 142 can then determine if the states are different and, if so, determine the state change is the effect of the control adjustment.

In the example of FIG. 1, the sensor monitoring system 142 can detect both the control adjustment of the switch 112 and the effect of the lighted portion 138a in the region 122. The sensor monitoring system 142 can then send the data related to the control adjustment of the switch 112 and the effect of the lighted portion 138a in the region 122 to the mapping engine 144.

The mapping engine 144 generates a mapping between controls and effects. In some implementations, the mapping engine 144 indicates controls and effects based on locations of controls and locations of effects. The mapping engine 144 can further indicate identifying information for controls and effects. For example, as shown in FIG. 1, the mapping engine 144 can indicate that the switch, identified as #switch_32, and at location ‘location_a’, controls a region indicated by ‘location_b’ observed by the camera 106 which is indicated as #device_44.

In some implementations, the control unit 101 stores information of devices on the property 102. For example, the control unit 101 can store information of the light 110 and the light 116. In some cases, the control unit 101 obtains information indicating a direction of the light 110 and the light 116. The information can be provided by a user or can be obtained based on detecting the light 110 and the light 116 in sensor data. For example, if a sensor obtains data of the light 110 and the light 116 and provides the data to the control unit 101, the control unit 101 can determine the direction of the light 110 and the light 116 based on a known location of the sensor and an apparent direction of the lights or based on known locations of objects in the data and the apparent direction of the lights.

In some implementations, the control unit 101 uses stored information of devices on the property to determine a device being controlled by an adjustment. For example, based on the control unit 101 obtaining information indicating a direction of the light 110 pointing towards the region 122 and the detected effect of the lighted portion 138a in the region 122, the control unit 101 can determine that the light 110 is being controlled by the adjustment of the switch 112. In this case, the #device_44 represents the light 110. The control unit 101 can obtain the location of the light 110 similar to the process for obtaining a direction of the camera. The mapping engine 144 of the control unit 101 can generate a mapping that indicates the location of the light 110. That is, the mapping engine 144 can generate a mapping between the control adjustment of the switch 112, indicated as #switch_32 located at location_a, and the effect of the lighted portion 138a provided by the light 110, indicated as #device_44 located at location_b.

In general, the mapping engine 144 can use any format for indicating a control and effect. For example, the mapping engine 144 can use semantic formations to describe the effect and the control causing the effect. The mapping engine 144 can use an identifier of the control, and indication that the control controls, and an indication of what the control controls. For example, the mapping engine 144 can generate a mapping that can be represented as control_a controls light in region_b.

The mapping engine 144 is communicably connected to the mapping database 148. The mapping engine 144 generates the mapping 146 that associates the control of the switch 112, indicated as #switch_32(location_a), with the effect of lighting the region 122, indicated as #device_44(location_b), where #switch_32(location_a) indicates the switch 112 located at location_a and #device_44(location_b) indicates either the observing camera 106 at location_b or the light 110 at location_b, depending on implementation.

In general, the sensor monitoring system 142 can process any number of images. The sensor monitoring system 142 can process any type of sensor data including sensor data that includes, audio, thermal, electromagnetic, such as infrared, Bluetooth, or other frequency signal, among other data types.

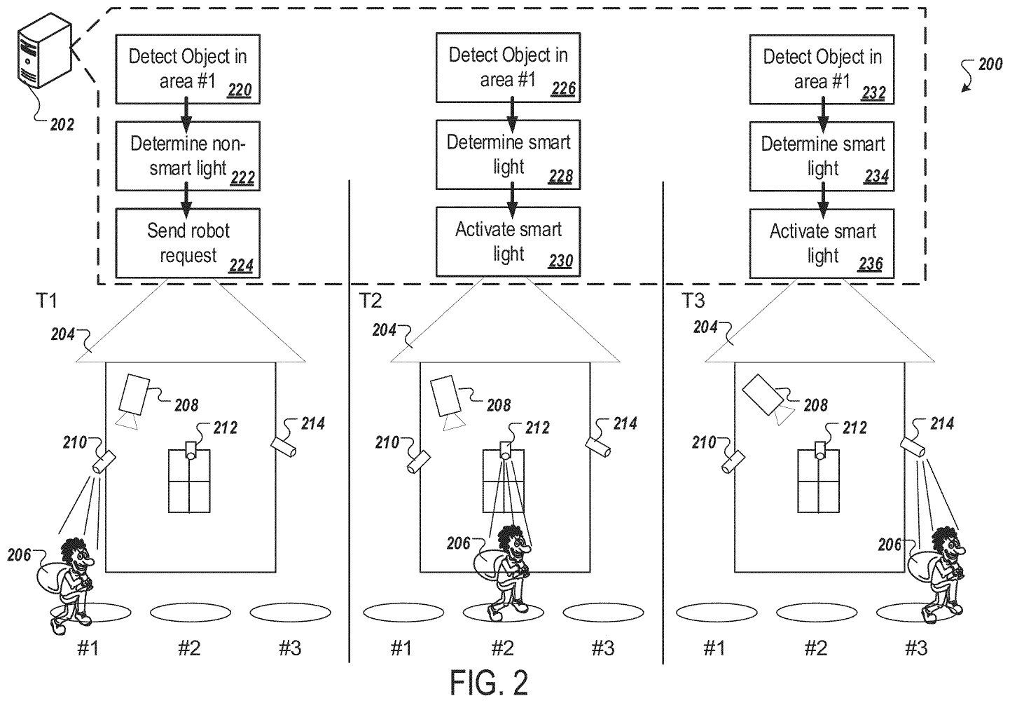

FIG. 2 is a diagram showing an example of a system 200 for assistive robotic manipulation of building controls manipulating building controls. The system 200 includes a control unit 202 that controls elements of the property 204. The system 200 includes elements of the property 204 including a camera 208, a light 210, a light 212, and a light 214.

At T1, the control unit 202 detects the person 206 in area #1 (220). The control unit 202 obtains the sensor data of the camera 208 from the camera 208. The control unit 202 processes the sensor data to determine an object that moves from a first time to a second time within sequential images captured by the camera 208. The camera 208 can be equipped with one or more motors to track moving objects detected in a scene. The control unit 202 can send signals to the camera 208 configured to adjust the direction of the camera 208 based on an expected location of an object based on a determined vector of motion. In some implementations, the camera 208 includes multiple cameras and sensors that detect objects in or around the property 204. The multiple cameras can be static or equipped with motors as described.

The control unit 202 determines that the light 210 is a non-smart light (222). For example, the control unit 202 can detect movement of the person 206 in area #1 and obtain a mapping of controls for the area #1. The mapping may indicate a control, e.g., an interface, for a device, such as the light 210. The mapping, or other information stored on a database communicably connected to the control unit 202, can indicate that the light 210 is not a smart light and therefore needs robotic assistance.

The control unit 202 sends a robot request (224). After determining that the light 210 effecting the area #1 is a non-smart light, the control unit 202 can generate a request for robot assistance. For example, the control unit 202 can send a signal to a robot, such as the robot 114, configured to activate the robot and provide the robot with directions to adjust a control mapped to the relevant device, such as the light 210. The control unit 202 can access a database, such as the mapping database 148 to determine what devices correspond to what controls and where the controls are. The mapping database 148 may also include maneuvers indicating how to adjust the control. The location, as well as additional instructions for adjusting the control, can be sent by the control unit 202 in the request to a robot. Maneuvers can include an orientation of the robot necessary to access an interface or control that controls a device, such as the light 210. For example, obstructions may prevent access to an interface or control from one or more directions or angles.

As shown in FIG. 2, the robot adjusts the control that controls the light 210 and the light 210 is activated in the area #1 thereby illuminating the person 206.

At time T2, the control unit 202 detects the person 206 in area #2 (226). As described for the detection of the person in area #1, the control unit 202 can obtain sensor data, such as the sensor data from the camera 208 or other sensor of the property 204, and process the data using one or more trained models to determine one or more objects. The control unit 202 can detect objects changing over time in order to determine movement of objects within a scene.

The control unit 202 determines that the light 212 is a smart light (228). For example, the control unit 202 can detect movement of the person 206 in area #2 and obtain a mapping of controls for the area #2. The mapping may indicate a control for a device, such as the light 212. The mapping, or other information stored on a database communicably connected to the control unit 202, can indicate that the light 212 is a smart light and therefore does not need robotic assistance.

The control unit 202 can then directly activate the smart light 212 (230). In some implementations, a smart light is unresponsive and needs robot assistance. For example, if the control unit 202 activates the light 212 and does not detect a corresponding change in state of the area #2, the control unit 202 can generate an alert. The alert can indicate the control used, intended effect, and the issue, such as the effect not being detected. The control unit 202 can send the alert to a user or use the alert to perform robotic assistance.

Robotic assistance for smart devices can include sending a request to a robot to reset the device. For example, smart devices can include components that can be controlled wirelessly or automatically by various processors. Sometimes, the smart devices can become unresponsive. To make them responsive, a user typically resets the smart device, e.g., unplugs and re-plugs the device or activates a reset switch or button.

When the control unit 202 detects that a control, based on a stored mapping, does not generate an expected effect, the control unit 202 can generate a signal configured to direct a robot to reset a corresponding device, and send the signal to one or more robots of a property. After one or more resetting attempts, the control unit 202 can send an alert to the user indicating that reset has been attempted but the issue persists. The alert can detail the issue and request human interaction to manually adjust the control or troubleshoot.

At T3, the control unit 202 detects the person 206 in area #3 (232). As described for the detection of the person in area #1 and #2, the control unit 202 can obtain sensor data, such as the sensor data from the camera 208 or other sensor of the property 204, and process the data using one or more trained models to determine one or more objects. The control unit 202 can detect objects changing over time in order to determine movement of objects within a scene.

The control unit 202 determines that the light 214 is a smart light (234). For example, the control unit 202 can detect the person 206 in area #3 and obtain a mapping of controls for the area #3. The mapping may indicate a control for a device, such as the light 214. The mapping, or other information stored on a database communicably connected to the control unit 202, can indicate that the light 214 is a smart light and therefore does not need robotic assistance.

The control unit 202 can then directly activate the smart light 214 (236). As discussed herein, robotic assistance can be used if the smart light 214 is unresponsive. As shown at T2 and T3, the smart lights 212 and 214 are activated to illuminate the person 206 as they move from area #2 to area #3.

In some implementations, lighting the person 206 improves the visual data obtained for the person 206 for use in surveillance or criminal investigations. The lighting may also serve as a deterrent to scare away trespassers. In addition to controlling the lighting of the person 206, the control unit 202 can provide an alert to a user of the property 204 indicating a potential trespasser as well as images obtained from the camera 208 or information of their location, such as regions the person is detected in e.g., area #1, #2, or #3, as well as geographic coordinates or locations relative to landmarks in or around the property 204.

Although separate lights are shown in FIG. 2, in some implementations, a single light performs the operations of two or more of the lights 210, 212, and 214. For example, a light can be affixed to the camera 208 or be similarly equipped with a motor to track objects. The control unit 202 can generate updates for the light similar to the updates provided to the camera 208 to adjust direction based on a location or predicted location of the person 206.

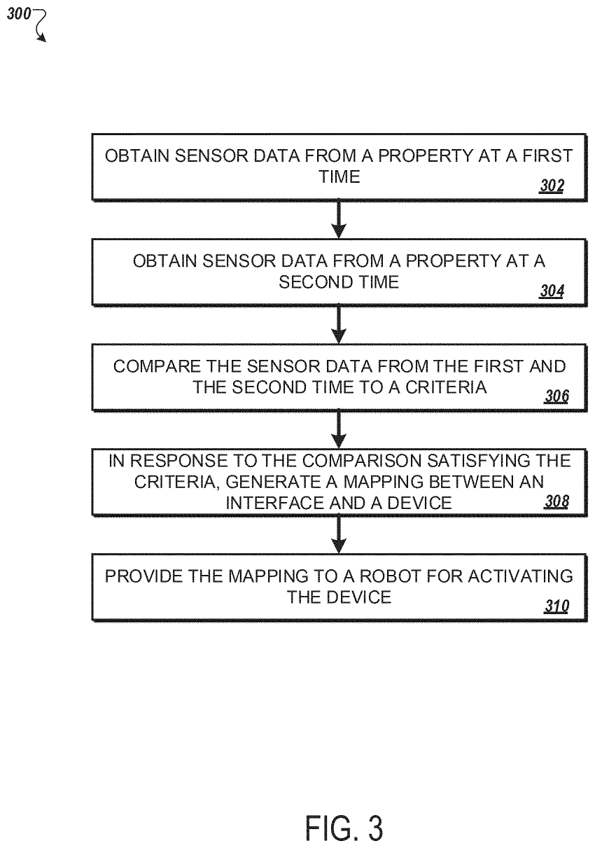

FIG. 3 is a flow diagram illustrating an example of a process 300 for assistive robotic manipulation of building controls. The process 300 may be performed by one or more electronic systems, for example, the system 100 of FIG. 1 or the system 200 of FIG. 2.

The process 300 includes obtaining sensor data from a property at a first time (302). For example, the control unit 101 obtains images 130, 132, and 134 from the property 102 at T1. T1 can indicate an exact time or a range of times before an adjustment to a control. In some cases, the control unit 101 uses sensor data, such as the images 130 and 136 to determine that the switch 112 has changed states and has therefore likely been adjusted.

The process 300 includes obtaining sensor data from a property at a second time (304). For example, the control unit 101 obtains images 136, 138, and 140 from the property 102 at T2. T2 can indicate an exact time or a range of times after an adjustment to a control. The adjustment to the control can be determined based on a signal generated by, and obtained from, a device of the property 102, such as the robot 114, or based on processing the data 128 as described herein.

The process 300 includes comparing the sensor data from the first and the second time to a criteria (306). For example, the sensor monitoring engine 142 of the control unit 101 can use one or more criteria. In some cases, criteria include comparing pixel values of image data obtained before a control adjustment to pixel values of image data obtained after a control adjustment and an average pixel change above a threshold satisfies the criteria. In some cases, the sensor monitoring engine 142 monitors sensors and determines various states of regions of the property 102. The sensor monitoring engine 142 can then determine if a first state, before a control adjustment, is different from a second state, after a control adjustment. The criteria can include the first state being different from the second state.

In some implementations, comparing the sensor data from the first and the second time to a criteria includes determining whether the sensor data from the first time and the second time satisfy a criteria. For example, the control unit 101 can determine, using the data 128 from T1 and T2 whether or not one or more criteria are satisfied. Criteria can include determining a difference between the sensor data from the first time and the sensor data from the second time; and comparing the difference to a threshold. In some implementations, the difference indicates a lighting change at or near the property.

In some implementations, determining whether the sensor data from the first time and the second time satisfy the criteria includes comparing one or more values of pixels of an image of the sensor data obtained from the property at the first time with one or more values of pixels of an image of the sensor data obtained from the property at the second time. For example, the control unit 101 can determine if one or more pixels have changed by comparing one or more values representing a pixel in a location of a first image from a first time to a second image from a second time. Change can be represented as a single value or set of values, e.g., RGB values. Change above a certain value can satisfy a criteria indicating that a device has effected a given area, e.g., has illuminated an area, has moved, among others. The control unit 101 can determine whether or not the changes satisfy one or more criteria.

In some implementations, determining whether the sensor data from the first time and the second time satisfy the criteria includes one or more steps of analysis. For example, one or more steps of analysis can include feature extraction and comparison or using a neural network to compare images, or other sensor data, e.g., based on one or more portions of an image. The control unit 101 can extract one or more features from sensor data obtained at a first time, e.g., images 130, 132, or 134, or one or more features from sensor data obtained at a second time, e.g., images 136, 138, or 140. In some implementations, the control unit 101 can compare features extracted from sensor data to determine whether the sensor data from the first time and the second time satisfy a criteria. For example, a criteria can include one or more distance values indicating a distance between vectors representing extracted features. The control unit 101 can operate one or more neural networks that can be trained to determine, using one or more input images, whether a criteria is satisfied, e.g., if sufficient activity, light, or other event has been detected in a sequence of images across time.

In some implementations, the robot 114 sends a signal to the sensor monitoring system 142 indicating that adjustments will be made or an adjustment has been made. For example, the robot 114 can send a signal to the sensor monitoring system 142 that the robot 114 will adjust the switch 112. The robot 114 can further include a time when the maneuver was completed. The sensor monitoring system 142 can then use the information to search for detected changes in the sensor data from before the time when the maneuver was completed to after the time when the maneuver was completed.

The process 300 includes, in response to the comparison satisfying the criteria, generating a mapping between an interface and a device (308). For example, the mapping engine 144 can generate a mapping between the light 110 and the switch 112. The mapping engine 144 can indicate that the switch 112, identified as #switch_32 at ‘location_a’, controls the light 110, indicated as #device_44 at ‘location_b’ observed by the camera 106.

The process 300 includes providing the mapping to a robot for activating the device (310). For example, the system 200 obtains a mapping between the light 210 and a control of the property 204 from a mapping database, such as the mapping database 148. The system 200 provides the mapping to a robot of the property 204 to activate the light 210 by sending a robot request (224). The robot request includes a location of the control and a method for adjusting the control in order to turn on the light 210.

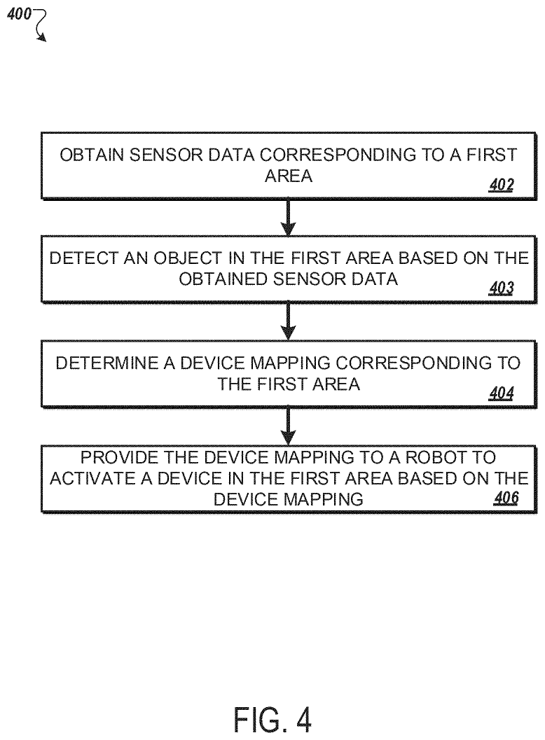

FIG. 4 is a flow diagram illustrating an example of a process 400 for an assistive robotic manipulation of building controls system manipulating building controls. The process 400 may be performed by one or more electronic systems, for example, the system 100 of FIG. 1 or the system 200 of FIG. 2.

The process 400 includes obtaining sensor data corresponding to a first area (402). For example, the control unit 202 detects the person 206 in the area #1. The control unit 202 obtains the sensor data of the camera 208 from the camera 208.

The process 400 includes detecting an object in the first area based on the obtained sensor data (404). For example, the control unit 202 processes the sensor data obtained from the camera 208 using one or more detection models to detect the person 206.

The process 400 includes determining a device mapping corresponding to the first area (406). For example, the control unit 202 determines that the device 210 is mapped to a control of the property 204, such as the switch 112 is mapped to the light 110. The control unit 202 may determine the device mapping based on querying a mapping database using a location of an affected region, such as area #1 or other identifiers of the light 210 or the control of the light 210.

The process 400 includes providing the device mapping to a robot to activate a device in the first area based on the device mapping (408). For example, the system 200 obtains a mapping between the light 210 and a control of the property 204 from a mapping database, such as the mapping database 148. The system 200 provides the mapping to a robot of the property 204 to activate the light 210 by sending a robot request (224). The robot request can include a location of the control and a method for adjusting the control in order to turn on the light 210.

In some implementations, a user of a system, such as the system 100 or 200, commands a robot with an app, by voice or gesture, or with an existing automation front end. For example, the system might function as part of a larger automation system. In some cases, the user may have a previously installed surveillance system and a few smart lights in the home, but has many “dumb” lights as well. The system can effectively “take over” the dumb lights, and make them appear as smart lights. The system may publish parameters to the system that define the limitations in control over these lights (e.g., the robot can only toggle one at a time, there may be variable latency as the robot accesses the switches, among others). The robot's status (e.g., online or offline) would be published as well, such that changing these lights might be effectively “grayed-out” or otherwise prevented when the robot is not available or otherwise engaged.

If there is a given automation schedule, or the system can infer a schedule based on learned user behavior over a period of time or known typically schedules on a property, such as turning the porch light on at dusk and off at dawn, the system, in some implementations, plans ahead to carry out the control adjustments required for the schedule. For example, the system can make sure (e.g., check a location or sensor data of the robot and send signals configured to move or control the robot to change the location) that the robot is charged and near the appropriate control (e.g., the control mapped to the porch light in the example of the porch light schedule) at the time it needs to be (e.g., the time indicated by the automated schedule, such as dusk and dawn in the porch light schedule), and would schedule charging, or other actions such as surveillance, for times when no automation changes were scheduled or likely, as predicted by the system based on aggregated data of past behavior on the property.

In some implementations, the system observes user behavior to learn new controls and new schedules. The system can then confirm or deny these controls or schedules before the system enables them. For example, the system can detect the user pushes the button on their coffeemaker every morning after they wake up (e.g., by recognizing the gesture, including detecting the objects of the user, a finger, and the coffeemaker, of a button press in sensor data, such as video). The system can prompt the user to confirm if they'd like this button pressed for them. The user can accept or deny the system performing this automation by interacting with an application connected to the system or by other controls such as voice control or gestures.

In some implementations, a system transfers automations to other properties. For example, if a user preference indicates that lights are turned on at 7 am at a first property, the system, controlling one or more robots or smart devices of a second property or personal devices such as a personal robot, can activate the lights of the second property at 7 am when the user is detected in the second property.

In some implementations, the system adjusts automations based on a given stimulus. For example, video analytics performed by a system, such as the system 100 or 200, detects an unknown person outside the home at night, as shown in FIG. 2. The system can turn on outside lights that are mapped to a location within a threshold distance from the detected location of the detected person, and also turn on a few inside lights that the system has learned are on that side of the house to simulate that someone is home and aware. In this way, the system can effectively improve the quality of visual data captured of the unknown person for possible identification or alerts, as well as potentially scare the person away.

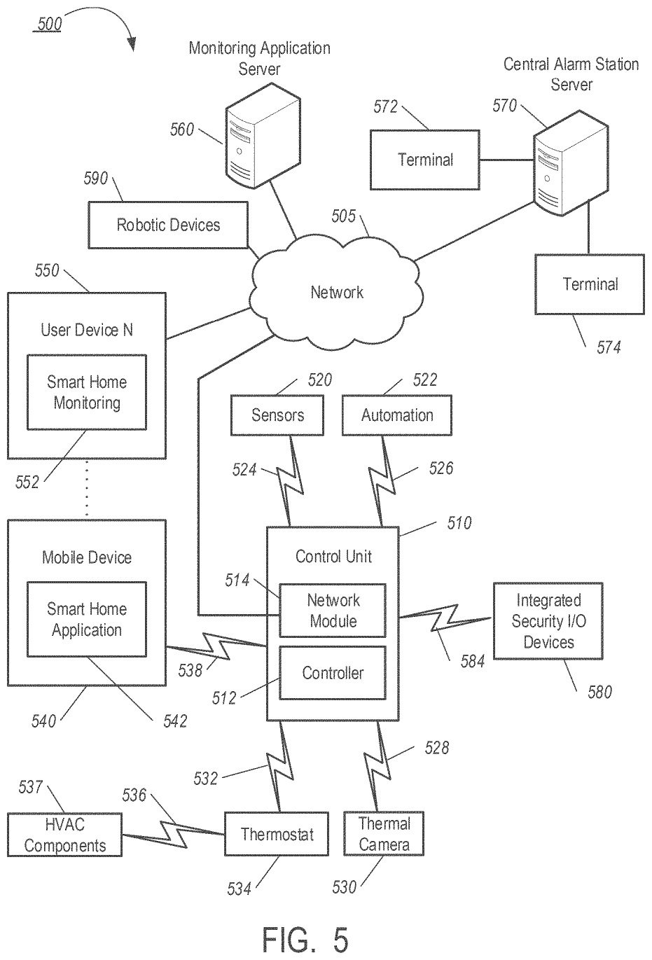

FIG. 5 is a diagram illustrating an example of a property monitoring system 500. In some cases, the property monitoring system 500 may include components of the system 100 of FIG. 1. For example, actions performed by the control unit 510 may include actions performed by the control unit 101.

The network 505 is configured to enable exchange of electronic communications between devices connected to the network 505. For example, the network 505 may be configured to enable exchange of electronic communications between the control unit 510, the one or more user devices 540 and 550, the monitoring server 560, and the central alarm station server 570. The network 505 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. The network 505 may include multiple networks or subnetworks, each of which may include, for example, a wired or wireless data pathway. The network 505 may include a circuit-switched network, a packet-switched data network, or any other network able to carry electronic communications (e.g., data or voice communications). For example, the network 505 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 505 may include one or more networks that include wireless data channels and wireless voice channels. The network 505 may be a wireless network, a broadband network, or a combination of networks including a wireless network and a broadband network.

The control unit 510 includes a controller 512 and a network module 514. The controller 512 is configured to control a control unit monitoring system (e.g., a control unit system) that includes the control unit 510. In some examples, the controller 512 may include a processor or other control circuitry configured to execute instructions of a program that controls operation of a control unit system. In these examples, the controller 512 may be configured to receive input from sensors, flow meters, or other devices included in the control unit system and control operations of devices included in the household (e.g., speakers, lights, doors, etc.). For example, the controller 512 may be configured to control operation of the network module 514 included in the control unit 510.

The network module 514 is a communication device configured to exchange communications over the network 505. The network module 514 may be a wireless communication module configured to exchange wireless communications over the network 505. For example, the network module 514 may be a wireless communication device configured to exchange communications over a wireless data channel and a wireless voice channel. In this example, the network module 514 may transmit alarm data over a wireless data channel and establish a two-way voice communication session over a wireless voice channel. The wireless communication device may include one or more of a LTE module, a GSM module, a radio modem, cellular transmission module, or any type of module configured to exchange communications in one of the following formats: LTE, GSM or GPRS, CDMA, EDGE or EGPRS, EV-DO or EVDO, UMTS, or IP.

The network module 514 also may be a wired communication module configured to exchange communications over the network 505 using a wired connection. For instance, the network module 514 may be a modem, a network interface card, or another type of network interface device. The network module 514 may be an Ethernet network card configured to enable the control unit 510 to communicate over a local area network and/or the Internet. The network module 514 also may be a voice band modem configured to enable the alarm panel to communicate over the telephone lines of Plain Old Telephone Systems (POTS).

The control unit system that includes the control unit 510 includes one or more sensors 520. For example, the monitoring system may include multiple sensors 520. The sensors 520 may include a lock sensor, a contact sensor, a motion sensor, or any other type of sensor included in a control unit system. The sensors 520 also may include an environmental sensor, such as a temperature sensor, a water sensor, a rain sensor, a wind sensor, a light sensor, a smoke detector, a carbon monoxide detector, an air quality sensor, etc. The sensors 520 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health monitoring sensor can be a wearable sensor that attaches to a user in the home. The health monitoring sensor can collect various health data, including pulse, heart rate, respiration rate, sugar or glucose level, bodily temperature, or motion data.

The sensors 520 can also include a radio-frequency identification (RFID) sensor that identifies a particular article that includes a pre-assigned RFID tag.

The system 500 also includes one or more thermal cameras 530 that communicate with the control unit 510. The thermal camera 530 may be an IR camera or other type of thermal sensing device configured to capture thermal images of a scene. For instance, the thermal camera 530 may be configured to capture thermal images of an area within a building or home monitored by the control unit 510. The thermal camera 530 may be configured to capture single, static thermal images of the area and also video thermal images of the area in which multiple thermal images of the area are captured at a relatively high frequency (e.g., thirty images per second). The thermal camera 530 may be controlled based on commands received from the control unit 510. In some implementations, the thermal camera 530 can be an IR camera that captures thermal images by sensing radiated power in one or more IR spectral bands, including NIR, SWIR, MWIR, and/or LWIR spectral bands.

The thermal camera 530 may be triggered by several different types of techniques. For instance, a Passive Infra-Red (PIR) motion sensor may be built into the thermal camera 530 and used to trigger the thermal camera 530 to capture one or more thermal images when motion is detected. The thermal camera 530 also may include a microwave motion sensor built into the camera and used to trigger the thermal camera 530 to capture one or more thermal images when motion is detected. The thermal camera 530 may have a “normally open” or “normally closed” digital input that can trigger capture of one or more thermal images when external sensors (e.g., the sensors 520, PIR, door/window, etc.) detect motion or other events. In some implementations, the thermal camera 530 receives a command to capture an image when external devices detect motion or another potential alarm event. The thermal camera 530 may receive the command from the controller 512 or directly from one of the sensors 520.

In some examples, the thermal camera 530 triggers integrated or external illuminators (e.g., Infra-Red or other lights controlled by the property automation controls 522, etc.) to improve image quality. An integrated or separate light sensor may be used to determine if illumination is desired and may result in increased image quality.

The thermal camera 530 may be programmed with any combination of time/day schedules, monitoring system status (e.g., “armed stay,” “armed away,” “unarmed”), or other variables to determine whether images should be captured or not when triggers occur. The thermal camera 530 may enter a low-power mode when not capturing images. In this case, the thermal camera 530 may wake periodically to check for inbound messages from the controller 512. The thermal camera 530 may be powered by internal, replaceable batteries if located remotely from the control unit 510. The thermal camera 530 may employ a small solar cell to recharge the battery when light is available. Alternatively, the thermal camera 530 may be powered by the controller's 512 power supply if the thermal camera 530 is co-located with the controller 512.

In some implementations, the thermal camera 530 communicates directly with the monitoring server 560 over the Internet. In these implementations, thermal image data captured by the thermal camera 530 does not pass through the control unit 510 and the thermal camera 530 receives commands related to operation from the monitoring server 560.

In some implementations, the system 500 includes one or more visible light cameras, which can operate similarly to the thermal camera 530, but detect light energy in the visible wavelength spectral bands. The one or more visible light cameras can perform various operations and functions within the property monitoring system 500. For example, the visible light cameras can capture images of one or more areas of the property, which the cameras, the control unit, and/or another computer system of the monitoring system 500 can process and analyze.

The system 500 also includes one or more property automation controls 522 that communicate with the control unit to perform monitoring. The property automation controls 522 are connected to one or more devices connected to the system 500 and enable automation of actions at the property. For instance, the property automation controls 522 may be connected to one or more lighting systems and may be configured to control operation of the one or more lighting systems. Also, the property automation controls 522 may be connected to one or more electronic locks at the property and may be configured to control operation of the one or more electronic locks (e.g., control Z-Wave locks using wireless communications in the Z-Wave protocol). Further, the property automation controls 522 may be connected to one or more appliances at the property and may be configured to control operation of the one or more appliances. The property automation controls 522 may include multiple modules that are each specific to the type of device being controlled in an automated manner. The property automation controls 522 may control the one or more devices based on commands received from the control unit 510. For instance, the property automation controls 522 may interrupt power delivery to a particular outlet of the property or induce movement of a smart window shade of the property.

The system 500 also includes thermostat 534 to perform dynamic environmental control at the property. The thermostat 534 is configured to monitor temperature and/or energy consumption of an HVAC system associated with the thermostat 534, and is further configured to provide control of environmental (e.g., temperature) settings. In some implementations, the thermostat 534 can additionally or alternatively receive data relating to activity at the property and/or environmental data at the home, e.g., at various locations indoors and outdoors at the property. The thermostat 534 can directly measure energy consumption of the HVAC system associated with the thermostat, or can estimate energy consumption of the HVAC system associated with the thermostat 534, for example, based on detected usage of one or more components of the HVAC system associated with the thermostat 534. The thermostat 534 can communicate temperature and/or energy monitoring information to or from the control unit 510 and can control the environmental (e.g., temperature) settings based on commands received from the control unit 510.

In some implementations, the thermostat 534 is a dynamically programmable thermostat and can be integrated with the control unit 510. For example, the dynamically programmable thermostat 534 can include the control unit 510, e.g., as an internal component to the dynamically programmable thermostat 534. In addition, the control unit 510 can be a gateway device that communicates with the dynamically programmable thermostat 534. In some implementations, the thermostat 534 is controlled via one or more property automation controls 522.

In some implementations, a module 537 is connected to one or more components of an HVAC system associated with the property, and is configured to control operation of the one or more components of the HVAC system. In some implementations, the module 537 is also configured to monitor energy consumption of the HVAC system components, for example, by directly measuring the energy consumption of the HVAC system components or by estimating the energy usage of the one or more HVAC system components based on detecting usage of components of the HVAC system. The module 537 can communicate energy monitoring information and the state of the HVAC system components to the thermostat 534 and can control the one or more components of the HVAC system based on commands received from the thermostat 534.

In some examples, the system 500 further includes one or more robotic devices 590. The robotic devices 590 may be any type of robot that are capable of moving and taking actions that assist in home monitoring. For example, the robotic devices 590 may include drones that are capable of moving throughout a property based on automated control technology and/or user input control provided by a user. In this example, the drones may be able to fly, roll, walk, or otherwise move about the property. The drones may include helicopter type devices (e.g., quad copters), rolling helicopter type devices (e.g., roller copter devices that can fly and/or roll along the ground, walls, or ceiling) and land vehicle type devices (e.g., automated cars that drive around a property). In some cases, the robotic devices 590 may be robotic devices 590 that are intended for other purposes and merely associated with the system 500 for use in appropriate circumstances. For instance, a robotic vacuum cleaner device may be associated with the monitoring system 500 as one of the robotic devices 590 and may be controlled to take action responsive to monitoring system events.

In some examples, the robotic devices 590 automatically navigate within a property. In these examples, the robotic devices 590 include sensors and control processors that guide movement of the robotic devices 590 within the property. For instance, the robotic devices 590 may navigate within the property using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 590 may include control processors that process output from the various sensors and control the robotic devices 590 to move along a path that reaches the desired destination and avoids obstacles. In this regard, the control processors detect walls or other obstacles in the property and guide movement of the robotic devices 590 in a manner that avoids the walls and other obstacles.

In addition, the robotic devices 590 may store data that describes attributes of the property. For instance, the robotic devices 590 may store a floorplan of a building on the property and/or a three-dimensional model of the property that enables the robotic devices 590 to navigate the property. During initial configuration, the robotic devices 590 may receive the data describing attributes of the property, determine a frame of reference to the data (e.g., a property or reference location in the property), and navigate the property based on the frame of reference and the data describing attributes of the property. Further, initial configuration of the robotic devices 590 also may include learning of one or more navigation patterns in which a user provides input to control the robotic devices 590 to perform a specific navigation action (e.g., fly to an upstairs bedroom and spin around while capturing video and then return to a home charging base). In this regard, the robotic devices 590 may learn and store the navigation patterns such that the robotic devices 590 may automatically repeat the specific navigation actions upon a later request.

In some examples, the robotic devices 590 may include data capture and recording devices. In these examples, the robotic devices 590 may include one or more cameras, one or more motion sensors, one or more microphones, one or more biometric data collection tools, one or more temperature sensors, one or more humidity sensors, one or more air flow sensors, and/or any other types of sensors that may be useful in capturing monitoring data related to the property and users at the property. The one or more biometric data collection tools may be configured to collect biometric samples of a person in the property with or without contact of the person. For instance, the biometric data collection tools may include a fingerprint scanner, a hair sample collection tool, a skin cell collection tool, and/or any other tool that allows the robotic devices 590 to take and store a biometric sample that can be used to identify the person (e.g., a biometric sample with DNA that can be used for DNA testing).

In some implementations, one or more of the thermal cameras 530 may be mounted on one or more of the robotic devices 590.

In some implementations, the robotic devices 590 may include output devices. In these implementations, the robotic devices 590 may include one or more displays, one or more speakers, and/or any type of output devices that allow the robotic devices 590 to communicate information to a nearby user.

The robotic devices 590 also may include a communication module that enables the robotic devices 590 to communicate with the control unit 510, each other, and/or other devices. The communication module may be a wireless communication module that allows the robotic devices 590 to communicate wirelessly. For instance, the communication module may be a Wi-Fi module that enables the robotic devices 590 to communicate over a local wireless network at the property. The communication module further may be a 900 MHz wireless communication module that enables the robotic devices 590 to communicate directly with the control unit 510. Other types of short-range wireless communication protocols, such as Bluetooth, Bluetooth LE, Z-wave, Zigbee, etc., may be used to allow the robotic devices 590 to communicate with other devices in the property. In some implementations, the robotic devices 590 may communicate with each other or with other devices of the system 500 through the network 505.

The robotic devices 590 further may include processor and storage capabilities. The robotic devices 590 may include any suitable processing devices that enable the robotic devices 590 to operate applications and perform the actions described throughout this disclosure. In addition, the robotic devices 590 may include solid state electronic storage that enables the robotic devices 590 to store applications, configuration data, collected sensor data, and/or any other type of information available to the robotic devices 590.

The robotic devices 590 can be associated with one or more charging stations. The charging stations may be located at predefined home base or reference locations at the property. The robotic devices 590 may be configured to navigate to the charging stations after completion of tasks needed to be performed for the monitoring system 500. For instance, after completion of a monitoring operation or upon instruction by the control unit 510, the robotic devices 590 may be configured to automatically fly to and land on one of the charging stations. In this regard, the robotic devices 590 may automatically maintain a fully charged battery in a state in which the robotic devices 590 are ready for use by the monitoring system 500.

The charging stations may be contact-based charging stations and/or wireless charging stations. For contact-based charging stations, the robotic devices 590 may have readily accessible points of contact that the robotic devices 590 are capable of positioning and mating with a corresponding contact on the charging station. For instance, a helicopter type robotic device 590 may have an electronic contact on a portion of its landing gear that rests on and mates with an electronic pad of a charging station when the helicopter type robotic device 590 lands on the charging station. The electronic contact on the robotic device 590 may include a cover that opens to expose the electronic contact when the robotic device 590 is charging and closes to cover and insulate the electronic contact when the robotic device is in operation.

For wireless charging stations, the robotic devices 590 may charge through a wireless exchange of power. In these cases, the robotic devices 590 need only locate themselves closely enough to the wireless charging stations for the wireless exchange of power to occur. In this regard, the positioning needed to land at a predefined home base or reference location in the property may be less precise than with a contact based charging station. Based on the robotic devices 590 landing at a wireless charging station, the wireless charging station outputs a wireless signal that the robotic devices 590 receive and convert to a power signal that charges a battery maintained on the robotic devices 590.

In some implementations, each of the robotic devices 590 has a corresponding and assigned charging station such that the number of robotic devices 590 equals the number of charging stations. In these implementations, the robotic devices 590 always navigate to the specific charging station assigned to that robotic device. For instance, a first robotic device 590 may always use a first charging station and a second robotic device 590 may always use a second charging station.

In some examples, the robotic devices 590 may share charging stations. For instance, the robotic devices 590 may use one or more community charging stations that are capable of charging multiple robotic devices 590. The community charging station may be configured to charge multiple robotic devices 590 in parallel. The community charging station may be configured to charge multiple robotic devices 590 in serial such that the multiple robotic devices 590 take turns charging and, when fully charged, return to a predefined home base or reference location in the property that is not associated with a charger. The number of community charging stations may be less than the number of robotic devices 590.

Also, the charging stations may not be assigned to specific robotic devices 590 and may be capable of charging any of the robotic devices 590. In this regard, the robotic devices 590 may use any suitable, unoccupied charging station when not in use. For instance, when one of the robotic devices 590 has completed an operation or is in need of battery charge, the control unit 510 references a stored table of the occupancy status of each charging station and instructs the robotic device 590 to navigate to the nearest charging station that is unoccupied.

The system 500 further includes one or more integrated security devices 580. The one or more integrated security devices may include any type of device used to provide alerts based on received sensor data. For instance, the one or more control units 510 may provide one or more alerts to the one or more integrated security input/output devices 580. Additionally, the one or more control units 510 may receive one or more sensor data from the sensors 520 and determine whether to provide an alert to the one or more integrated security input/output devices 580.

The sensors 520, the property automation controls 522, the thermal camera 530, the thermostat 534, and the integrated security devices 580 may communicate with the controller 512 over communication links 524, 526, 528, 532, and 584. The communication links 524, 526, 528, 532, and 584 may be a wired or wireless data pathway configured to transmit signals from the sensors 520, the property automation controls 522, the thermal camera 530, the thermostat 534, and the integrated security devices 580 to the controller 512. The sensors 520, the property automation controls 522, the thermal camera 530, the thermostat 534, and the integrated security devices 580 may continuously transmit sensed values to the controller 512, periodically transmit sensed values to the controller 512, or transmit sensed values to the controller 512 in response to a change in a sensed value.

The communication links 524, 526, 528, 532, and 584 may include a local network. The sensors 520, the property automation controls 522, the thermal camera 530, the thermostat 534, and the integrated security devices 580, and the controller 512 may exchange data and commands over the local network. The local network may include 802.11 “Wi-Fi” wireless Ethernet (e.g., using low-power Wi-Fi chipsets), Z-Wave, Zigbee, Bluetooth, “Homeplug” or other “Powerline” networks that operate over AC wiring, and a Category 5 (CAT5) or Category 6 (CAT6) wired Ethernet network. The local network may be a mesh network constructed based on the devices connected to the mesh network.

The monitoring server 560 is one or more electronic devices configured to provide monitoring services by exchanging electronic communications with the control unit 510, the one or more user devices 540 and 550, and the central alarm station server 570 over the network 505. For example, the monitoring server 560 may be configured to monitor events (e.g., alarm events) generated by the control unit 510. In this example, the monitoring server 560 may exchange electronic communications with the network module 514 included in the control unit 510 to receive information regarding events (e.g., alerts) detected by the control unit 510. The monitoring server 560 also may receive information regarding events (e.g., alerts) from the one or more user devices 540 and 550.

In some examples, the monitoring server 560 may route alert data received from the network module 514 or the one or more user devices 540 and 550 to the central alarm station server 570. For example, the monitoring server 560 may transmit the alert data to the central alarm station server 570 over the network 505.

The monitoring server 560 may store sensor data, thermal image data, and other monitoring system data received from the monitoring system and perform analysis of the sensor data, thermal image data, and other monitoring system data received from the monitoring system. Based on the analysis, the monitoring server 560 may communicate with and control aspects of the control unit 510 or the one or more user devices 540 and 550.

The monitoring server 560 may provide various monitoring services to the system 500. For example, the monitoring server 560 may analyze the sensor, thermal image, and other data to determine an activity pattern of a resident of the property monitored by the system 500. In some implementations, the monitoring server 560 may analyze the data for alarm conditions or may determine and perform actions at the property by issuing commands to one or more of the automation controls 522, possibly through the control unit 510.

The central alarm station server 570 is an electronic device configured to provide alarm monitoring service by exchanging communications with the control unit 510, the one or more mobile devices 540 and 550, and the monitoring server 560 over the network 505. For example, the central alarm station server 570 may be configured to monitor alerting events generated by the control unit 510. In this example, the central alarm station server 570 may exchange communications with the network module 514 included in the control unit 510 to receive information regarding alerting events detected by the control unit 510. The central alarm station server 570 also may receive information regarding alerting events from the one or more mobile devices 540 and 550 and/or the monitoring server 560.

The central alarm station server 570 is connected to multiple terminals 572 and 574. The terminals 572 and 574 may be used by operators to process alerting events. For example, the central alarm station server 570 may route alerting data to the terminals 572 and 574 to enable an operator to process the alerting data. The terminals 572 and 574 may include general-purpose computers (e.g., desktop personal computers, workstations, or laptop computers) that are configured to receive alerting data from a server in the central alarm station server 570 and render a display of information based on the alerting data. For instance, the controller 512 may control the network module 514 to transmit, to the central alarm station server 570, alerting data indicating that a sensor 520 detected motion from a motion sensor via the sensors 520. The central alarm station server 570 may receive the alerting data and route the alerting data to the terminal 572 for processing by an operator associated with the terminal 572. The terminal 572 may render a display to the operator that includes information associated with the alerting event (e.g., the lock sensor data, the motion sensor data, the contact sensor data, etc.) and the operator may handle the alerting event based on the displayed information.

In some implementations, the terminals 572 and 574 may be mobile devices or devices designed for a specific function. Although FIG. 5 illustrates two terminals for brevity, actual implementations may include more (and, perhaps, many more) terminals.

The one or more authorized user devices 540 and 550 are devices that host and display user interfaces. For instance, the user device 540 is a mobile device that hosts or runs one or more native applications (e.g., the smart home application 542). The user device 540 may be a cellular phone or a non-cellular locally networked device with a display. The user device 540 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, Phone-type devices (e.g., as provided by Apple), Pod devices (e.g., as provided by Apple) or other portable music players, other communication devices, and handheld or portable electronic devices for gaming, communications, and/or data organization. The user device 540 may perform functions unrelated to the monitoring system, such as placing personal telephone calls, playing music, playing video, displaying pictures, browsing the Internet, maintaining an electronic calendar, etc.

The user device 540 includes a smart home application 542. The smart home application 542 refers to a software/firmware program running on the corresponding mobile device that enables the user interface and features described throughout. The user device 540 may load or install the smart home application 542 based on data received over a network or data received from local media. The smart home application 542 runs on mobile devices platforms, such as iPhone, iPod touch, Blackberry, Google Android, Windows Mobile, etc. The smart home application 542 enables the user device 540 to receive and process image and sensor data from the monitoring system.

The user device 550 may be a general-purpose computer (e.g., a desktop personal computer, a workstation, or a laptop computer) that is configured to communicate with the monitoring server 560 and/or the control unit 510 over the network 505. The user device 550 may be configured to display a smart home user interface 552 that is generated by the user device 550 or generated by the monitoring server 560. For example, the user device 550 may be configured to display a user interface (e.g., a web page) provided by the monitoring server 560 that enables a user to perceive images captured by the thermal camera 530 and/or reports related to the monitoring system. Although FIG. 5 illustrates two user devices for brevity, actual implementations may include more (and, perhaps, many more) or fewer user devices.

The smart home application 542 and the smart home user interface 552 can allow a user to interface with the property monitoring system 500, for example, allowing the user to view monitoring system settings, adjust monitoring system parameters, customize monitoring system rules, and receive and view monitoring system messages.

In some implementations, the one or more user devices 540 and 550 communicate with and receive monitoring system data from the control unit 510 using the communication link 538. For instance, the one or more user devices 540 and 550 may communicate with the control unit 510 using various local wireless protocols such as Wi-Fi, Bluetooth, Z-wave, Zigbee, HomePlug (ethernet over power line), or wired protocols such as Ethernet and USB, to connect the one or more user devices 540 and 550 to local security and automation equipment. The one or more user devices 540 and 550 may connect locally to the monitoring system and its sensors and other devices. The local connection may improve the speed of status and control communications because communicating through the network 505 with a remote server (e.g., the monitoring server 560) may be significantly slower.

Although the one or more user devices 540 and 550 are shown as communicating with the control unit 510, the one or more user devices 540 and 550 may communicate directly with the sensors 520 and other devices controlled by the control unit 510. In some implementations, the one or more user devices 540 and 550 replace the control unit 510 and perform the functions of the control unit 510 for local monitoring and long range/offsite communication.

In other implementations, the one or more user devices 540 and 550 receive monitoring system data captured by the control unit 510 through the network 505. The one or more user devices 540, 550 may receive the data from the control unit 510 through the network 505 or the monitoring server 560 may relay data received from the control unit 510 to the one or more user devices 540 and 550 through the network 505. In this regard, the monitoring server 560 may facilitate communication between the one or more user devices 540 and 550 and the monitoring system 500.

In some implementations, the one or more user devices 540 and 550 may be configured to switch whether the one or more user devices 540 and 550 communicate with the control unit 510 directly (e.g., through link 538) or through the monitoring server 560 (e.g., through network 505) based on a location of the one or more user devices 540 and 550. For instance, when the one or more user devices 540 and 550 are located close to the control unit 510 and in range to communicate directly with the control unit 510, the one or more user devices 540 and 550 use direct communication. When the one or more user devices 540 and 550 are located far from the control unit 510 and not in range to communicate directly with the control unit 510, the one or more user devices 540 and 550 use communication through the monitoring server 560.

Although the one or more user devices 540 and 550 are shown as being connected to the network 505, in some implementations, the one or more user devices 540 and 550 are not connected to the network 505. In these implementations, the one or more user devices 540 and 550 communicate directly with one or more of the monitoring system components and no network (e.g., Internet) connection or reliance on remote servers is needed.

In some implementations, the one or more user devices 540 and 550 are used in conjunction with only local sensors and/or local devices in a house. In these implementations, the system 500 includes the one or more user devices 540 and 550, the sensors 520, the property automation controls 522, the thermal camera 530, and the robotic devices 590. The one or more user devices 540 and 550 receive data directly from the sensors 520, the property automation controls 522, the thermal camera 530, and the robotic devices 590 (i.e., the monitoring system components) and sends data directly to the monitoring system components. The one or more user devices 540, 550 provide the appropriate interfaces/processing to provide visual surveillance and reporting.

In other implementations, the system 500 further includes network 505 and the sensors 520, the property automation controls 522, the thermal camera 530, the thermostat 534, and the robotic devices 59 are configured to communicate sensor and image data to the one or more user devices 540 and 550 over network 505 (e.g., the Internet, cellular network, etc.). In yet another implementation, the sensors 520, the property automation controls 522, the thermal camera 530, the thermostat 534, and the robotic devices 590 (or a component, such as a bridge/router) are intelligent enough to change the communication pathway from a direct local pathway when the one or more user devices 540 and 550 are in close physical proximity to the sensors 520, the property automation controls 522, the thermal camera 530, the thermostat 534, and the robotic devices 590 to a pathway over network 505 when the one or more user devices 540 and 550 are farther from the sensors 520, the property automation controls 522, the thermal camera 530, the thermostat 534, and the robotic devices 590. In some examples, the system leverages GPS information from the one or more user devices 540 and 550 to determine whether the one or more user devices 540 and 550 are close enough to the monitoring system components to use the direct local pathway or whether the one or more user devices 540 and 550 are far enough from the monitoring system components that the pathway over network 505 is required. In other examples, the system leverages status communications (e.g., pinging) between the one or more user devices 540 and 550 and the sensors 520, the property automation controls 522, the thermal camera 530, the thermostat 534, and the robotic devices 590 to determine whether communication using the direct local pathway is possible. If communication using the direct local pathway is possible, the one or more user devices 540 and 550 communicate with the sensors 520, the property automation controls 522, the thermal camera 530, the thermostat 534, and the robotic devices 590 using the direct local pathway. If communication using the direct local pathway is not possible, the one or more user devices 540 and 550 communicate with the monitoring system components using the pathway over network 505.

In some implementations, the system 500 provides end users with access to thermal images captured by the thermal camera 530 to aid in decision making. The system 500 may transmit the thermal images captured by the thermal camera 530 over a wireless WAN network to the user devices 540 and 550. Because transmission over a wireless WAN network may be relatively expensive, the system 500 can use several techniques to reduce costs while providing access to significant levels of useful visual information (e.g., compressing data, down-sampling data, sending data only over inexpensive LAN connections, or other techniques).

In some implementations, a state of the monitoring system and other events sensed by the monitoring system may be used to enable/disable video/image recording devices (e.g., the thermal camera 530 or other cameras of the system 500). In these implementations, the thermal camera 530 may be set to capture thermal images on a periodic basis when the alarm system is armed in an “armed away” state, but set not to capture images when the alarm system is armed in an “armed stay” or “unarmed” state. In addition, the thermal camera 530 may be triggered to begin capturing thermal images when the alarm system detects an event, such as an alarm event, a door-opening event for a door that leads to an area within a field of view of the thermal camera 530, or motion in the area within the field of view of the thermal camera 530. In other implementations, the thermal camera 530 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random-access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure. A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the processes 300 and 400 of FIG. 3 and FIG. 4 can be performed in a different order and still achieve desirable results.

What is claimed is:

1. A method comprising:
obtaining sensor data from a property at a first time;
obtaining sensor data from the property at a second time;
determining whether the sensor data from the first time and the second time satisfy a criteria;
in response to determining the criteria is satisfied, generating a mapping between an interface and a device; and
providing the mapping to a robot for activating the device.

2. The method of claim 1, wherein the interface is configured to control the device.

3. The method of claim 1, wherein determining whether the sensor data from the first time and the second time satisfy the criteria includes:
determining a difference between the sensor data from the first time and the sensor data from the second time; and
comparing the difference to a threshold.

4. The method of claim 1, wherein:
the sensor data from the property at the first time indicates a first status of the interface configured to control the device, and
the sensor data from the property at the second time indicates (i) a second status, different than the first status, of the interface configured to control the device and (ii) an effect of the device being controlled by the interface.

5. The method of claim 4, wherein the effect of the device being controlled by the interface includes illumination of a portion of the property or area near the property.

6. The method of claim 4, wherein determining whether the sensor data from the first time and the second time satisfy the criteria includes:
comparing the first status of the interface configured to control the device with the second status of the interface configured to control the device.

7. The method of claim 6, comprising:
determining that the comparison satisfies the criteria by determining the first status of the interface configured to control the device is different than the second status.

8. The method of claim 1, wherein determining whether the sensor data from the first time and the second time satisfy the criteria includes:
comparing one or more values of pixels of an image of the sensor data obtained from the property at the first time with one or more values of pixels of an image of the sensor data obtained from the property at the second time.

9. The method of claim 1, prior to providing the mapping to the robot for activating the device, comprising:
obtaining sensor data corresponding to a first area of the property;
detecting an object in the first area using the obtained sensor data; and
determining that the device is mapped to and effects the first area.

10. The method of claim 9, comprising providing the mapping to the robot for activating the device in response to:
detecting the object in the first area using the obtained sensor data; and
determining that the device is mapped and effects the first area.

11. The method of claim 1, comprising:
determining the device is not a smart device and is configured to be controlled by the interface.

12. The method of claim 11, wherein determining the device is not a smart device and is configured to be controlled by the interface includes:
maintaining data indicating detection of movement of a person interacting with the interface.

13. The method of claim 1, wherein the interface is a physical switch or physical button.

14. The method of claim 1, wherein providing the mapping to the robot for activating the device comprises:
providing a location of the interface to the robot.

15. The method of claim 1, wherein providing the mapping to the robot for activating the device comprises:
providing instructions to the robot indicating how to access the interface controlling the device.

16. The method of claim 15, wherein the instructions include flight maneuvers for the robot to perform to access a portion of the interface.

17. A non-transitory computer-readable medium storing one or more instructions executable by a computer system to perform operations comprising:
obtaining sensor data from a property at a first time;
obtaining sensor data from the property at a second time;
determining whether the sensor data from the first time and the second time satisfy a criteria;
in response to determining the criteria is satisfied, generating a mapping between an interface and a device; and
providing the mapping to a robot for activating the device.

18. The medium of claim 17, wherein the interface is configured to control the device.

19. The medium of claim 17, wherein determining whether the sensor data from the first time and the second time satisfy the criteria includes:
determining a difference between the sensor data from the first time and the sensor data from the second time; and
comparing the difference to a threshold.

20. A system, comprising:
one or more processors; and
machine-readable media interoperably coupled with the one or more processors and storing one or more instructions that, when executed by the one or more processors, perform operations comprising:
obtaining sensor data from a property at a first time;
obtaining sensor data from the property at a second time;
determining whether the sensor data from the first time and the second time satisfy a criteria;
in response to determining the criteria is satisfied, generating a mapping between an interface and a device; and
providing the mapping to a robot for activating the device.
